(19) United States
(12) Patent Application Publication
(10) Pub. No.: US 2011/0298902 A1
(43) Pub. Date: Dec. 8, 2011

(54) SHUTTER GLASSES FOR 3D IMAGE DISPLAY, 3D IMAGE DISPLAY SYSTEM INCLUDING THE SAME, AND MANUFACTURING METHOD THEREOF

(76) Inventors: So-Young KIM, Suwon-si (KR); Seung-Ho AHN, Seongnam-si (KR); Dong-Ho LEE, Yongin-si (KR)

(21) Appl. No.: 12/962,406

(22) Filed: Dec. 7, 2010

(30) Foreign Application Priority Data
Jun. 4, 2010 (KR) 10-2010-0052877

(51) Int. Cl. H04N 13/04; G02B 26/02

(52) U.S. Cl. 348/51; 359/230; 359/229; 348/E13.075

(57) ABSTRACT

Provided are a shutter glasses for a 3D image display, a 3D image display system including the same, and a manufacturing method thereof. Shutter glasses for a 3D image display system according to an exemplary embodiment of the present invention include a left eye shutter and a right eye shutter. At least one of the left eye shutter and the right eye shutter includes a MEMS element controlling an opening and a closing of the at least one of the left eye shutter and the right eye shutter.

### CROSS-REFERENCE TO RELATED APPLICATION

This application claims priority to, and the benefit of, Korean Patent Application No. 10-2010-0052877 filed in the Korean Intellectual Property Office on Jun. 4, 2010, the entire contents of which are incorporated herein by reference.

### BACKGROUND OF THE INVENTION

(a) Field of the Invention

The present invention relates generally to flat panel displays. More specifically, the present invention relates to shutter glasses for a 3D image flat panel display, a 3D image display system including the same, and a manufacturing method thereof.

(b) Description of the Related Art

In 3D image display technology, in general, a 3D appearance of an object is generated by binocular parallax, which is the biggest cause of 3D appearance perception at close range. That is, different images are seen by the left eye and the right eye. Hereinafter, an image seen by the left eye is referred to as a left eye image and an image seen by the right eye is referred to as a right eye image. A left eye image and a right eye image are transmitted to the brain, which combines the left eye image and the right eye image to perceive them as a 3D image having depth.

A 3D image display typically takes advantage of binocular parallax, and is either a stereoscopic type display that uses glasses such as shutter glasses and polarized glasses, or an autostereoscopic type display in which glasses are not used. Instead, the autostereoscopic type display often employs a lenticular lens, a parallax barrier, and/or others disposed in the display.

The stereoscopic type display produces images via a method in which a 3D image display continuously outputs separate left and right eye images, and left and right eye shutters of shutter glasses are selectively opened and closed.

Shutter glasses having two substrates and a liquid crystal interposed therebetween are being developed. However, these types of shutter glasses are currently too thick and heavy for convenient use. Moreover, shutter glasses currently exhibit excessively slow response speed. Additionally, a response speed difference between a display and shutter glasses may complicate image display.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides shutter glasses for a 3D image display including a left eye shutter and a right eye shutter. At least one of the left eye shutter and the right eye shutter includes a MEMS element controlling an opening and a closing of the at least one of the left eye shutter and the right eye shutter.

Another embodiment of the present invention provides a 3D image display system including: a display configured to alternately display left eye images and right eye image; and shutter glasses including a left eye shutter and a right eye shutter. At least one of the left eye shutter and the right eye shutter includes a MEMS element controlling an opening and a closing of the at least one of the left eye shutter and the right eye shutter.

The MEMS element may include a control electrode formed on a substrate, and a shutter formed in electrical communication with the control electrode and capable of being opened and closed.

An antireflective layer formed on a top surface of the shutter may be further included.

A fixed electrode configured to fix the shutter and apply signals to the shutter may be further included.

The MEMS element may actuate the shutter in response to a synchronization signal from the display.

The left eye shutter and the right eye shutter of the shutter glasses are actuated so as to be opened in an alternating manner.

The MEMS element may include an aperture plate formed of a light-blocking material and having at least one opening, and a shutter configured to prevent light from passing through the opening.

a control electrode configured to control the position of the shutter may be further included.

A first substrate and a second substrate facing each other with the MEMS element interposed therebetween may be further included. Wiring lines may be formed on the first substrate, the wiring lines being connected to the control electrodes so as to apply signals to the control electrodes. Additionally, the aperture plate may be formed on the second substrate.

A first substrate and a second substrate facing each other with the MEMS element interposed therebetween may be further included. Wiring lines may be formed on a first surface of the first substrate, the wiring lines being connected to the control electrodes so as to apply signals to the control electrodes. The aperture plate may be formed on a second surface of the first substrate, the second surface being opposite to the first surface.

The shutter may have a first position when a signal is not applied to the control electrode and a second position when the signal is applied to the control electrode. A restoring unit may also be included, where the restoring unit is configured to provide a restoring force returning the shutter to the first position.

Yet another embodiment of the present invention provides a method of manufacturing shutter glasses including a left eye shutter and a right eye shutter for a 3D image display, where the method includes fabricating a MEMS element within at least one of the left eye shutter and the right eye shutter the MEMS element configured to control an opening and a closing of the at least one of the left eye shutter and the right eye shutter.

Yet another embodiment of the present invention provides a method of manufacturing a 3D image display system including: preparing a display for alternately displaying left eye images and right eye images; and preparing shutter glasses including a left eye shutter and a right eye shutter. At least one of the left eye shutter and the right eye shutter includes a MEMS element.

Shutter glasses for a 3D image display according to an exemplary embodiment of the present invention include MEMS elements controlling an opening and a closing of shutters of the shutter glasses.

### BRIEF DESCRIPTION OF THE DRAWINGS

FIG. 1 is a drawing schematically illustrating the operation of a 3D image display system according to an exemplary embodiment of the present invention;

FIG. 2 is a block diagram illustrating a 3D image display system according to an exemplary embodiment of the present invention;

FIG. 3 is a graph illustrating a driving method of a 3D image display system according to an exemplary embodiment of the present invention;

FIG. 4 is a graph illustrating a driving method of a 3D image display system according to another exemplary embodiment of the present invention;

FIG. 5 is a cross-sectional view illustrating the cross-sectional structure of shutter glasses according to an exemplary embodiment of the present invention in which shutters are in a closed state;

FIG. 6 is a cross-sectional view illustrating the cross-sectional structure of shutter glasses according to an exemplary embodiment of the present invention in which shutters are in an opened state;

FIG. 7 is a cross-sectional view illustrating the cross-sectional structure of shutter glasses according to another exemplary embodiment of the present invention in which shutters are in an opened state;

FIG. 8 is a drawing illustrating a layout of a first substrate of shutter glasses according to an exemplary embodiment of the present invention;

FIG. 9 is a cross-sectional view of the shutter glasses shown in FIG. 8 as taken along a line IX-IX′;

FIG. 10 is another example of the cross-sectional view of the shutter glasses shown in FIG. 8 as taken along the line IX-IX′;

FIG. 11 is a cross-sectional view of shutter glasses according to an exemplary embodiment of the present invention in which openings have been closed by shutters;

FIG. 12 is a cross-sectional view of shutter glasses according to an exemplary embodiment of the present invention in which openings have been opened by shutters;

FIG. 13 is a cross-sectional view of shutter glasses according to another exemplary embodiment of the present invention in which openings have been closed by shutters;

FIG. 14 is a cross-sectional view of shutter glasses according to another exemplary embodiment of the present invention in which openings have been closed by shutters; and

FIG. 15 is a cross-sectional view of shutter glasses according to another exemplary embodiment of the present invention in which openings have been opened by shutters.

### DETAILED DESCRIPTION OF THE EMBODIMENTS

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification. Further, a detailed description of well-known techniques is omitted.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

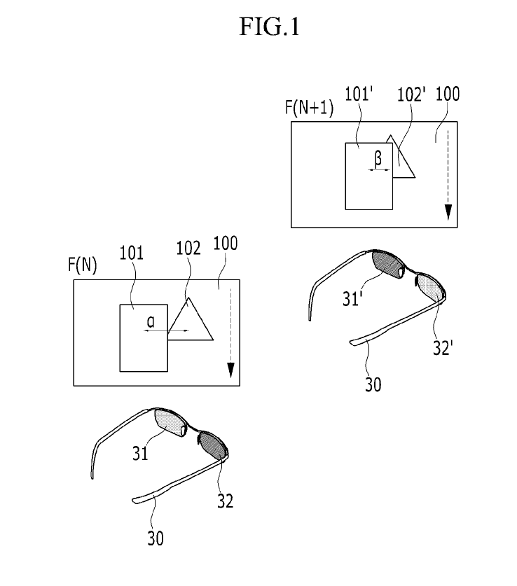

Now, a 3D image display system according to an exemplary embodiment of the present invention will be described in detail with reference to FIGS. 1 to 4.

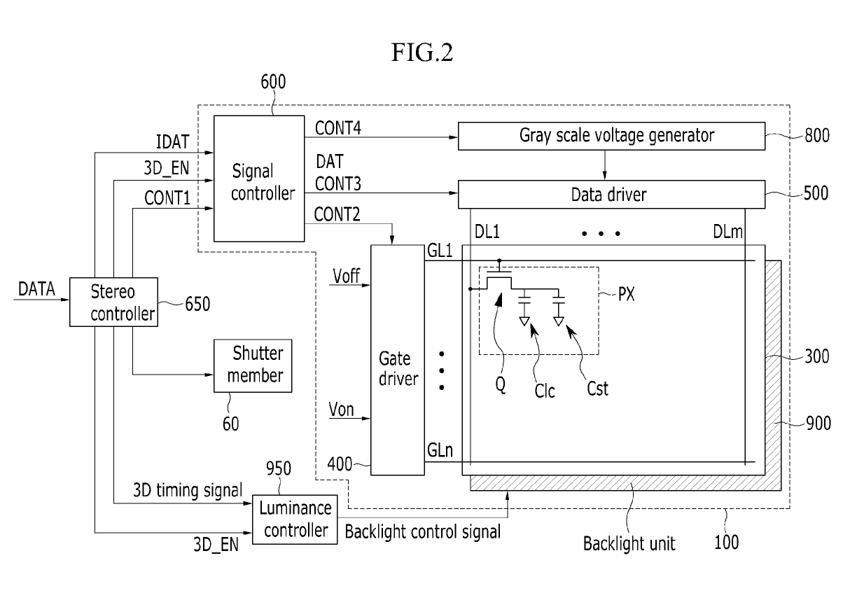

FIG. 1 is a drawing schematically illustrating the operation of a 3D image display system according to an exemplary embodiment of the present invention, and FIG. 2 is a block diagram illustrating a 3D image display system according to an exemplary embodiment of the present invention.

Referring to FIG. 1, a 3D image display system includes a display 100 for displaying images, and shutter glasses 30 serving as a shutter member. The shutter member is shown here in the form of a pair of glasses, although the invention also contemplates any other suitable form of shutter member. For example, the shutter member may be formed as mechanical shutter glasses (goggles), optical shutter glasses, a head mount, etc.

A right eye shutter (32, 32′) and a left eye shutter (31, 31′) of the shutter glasses 30 are actuated so as to alternately block out light during a predetermined period in sync with the display 100. The right eye shutter may be a closed right eye shutter 32 or an opened right eye shutter 32′, and a left eye shutter may be an opened left eye shutter 31 or a closed left eye shutter 31′. For example, the left eye shutter may be in a closed state while the right eye shutter is in an opened state. In contrast, the right eye shutter may be in a closed state while the left eye shutter is in an opened state. Alternatively, both of the left eye shutter and the right eye shutter may be in an opened state or in a closed state.

A shutter of the shutter member may be formed by using a specifically configured micro electromechanical system (hereinafter, referred to as MEMS). Here, MEMS refers to micro-fabrication technology and electromechanical systems thereof, and MEMS devices may be devices having electronic and mechanical elements with dimensions from 0.0001 micrometers to 1000 micrometers. A MEMS is also called a micro machine, a micro system, etc. MEMS may be fabricated through processes similar to semiconductor element fabrication processes. In particular a mechanical structure may be fabricated by forming various patterns on a substrate formed of, for example, silicon and performing etching with, for example, etchant chemicals. The structure of the shutter member such as the shutter glasses 30 using MEMS elements will be described below.

Referring to FIG. 1, when a left eye image (101, 102) is output to the display 100, the left eye shutter 31 of the shutter glasses 30 is placed in its opened state to allow penetration of light, and the right eye shutter 32 enters its closed state to block out light. Further, a right eye image (101′, 102′) is output to the display 100, the right eye shutter 32′ enters its opened state to allow penetration of light, and the left eye shutter 31′ is placed in its closed state to block out light. Therefore, during one predetermined period, the left eye image is perceived by the user's left eye, and during the next predetermined period, the right eye image is perceived by the user's right eye. From these two images, the user's brain generates a 3D image having depth perception.

In this example, the image perceived by the left eye is a picture displayed in an N-th frame F(N), that is, a picture in which a distance between the center of a tetragonal left eye image 101 and the center of a triangular left eye image 102 is α. Meanwhile, the image perceived by the right eye is a picture displayed in an (N+1)-th frame F(N+1), that is, a picture in which a distance between the center of a tetragonal right eye image 101′ and the center of a triangular right eye image 102′ is β. Here, α and β may have different values. When the distance between the image centers perceived by the left eye is different from the distance between the image centers perceived by the right eye as described above (i.e., when α and β are different), this difference brings different perceptions of distance with respect to the tetragon and the triangle. This results in the perception that the triangle is behind and away from the tetragon. Accordingly, depth perception is felt. The distances α and β between the centers of the triangle and the tetragon may be adjusted to control the perceived distance between both objects (depth perception).

MEMS elements can exhibit high response speed, and are thus capable of quickly responding to signals of a display. Therefore, MEMS elements are very useful for synchronization with a display.

In the present exemplary embodiment, a 3D image display system employs shutter glasses with MEMS elements. However, it should be noted that these MEMS-containing shutter glasses may also be used for displaying images other than 3D images.

Next, referring to FIG. 2, a 3D image display system according to an exemplary embodiment of the present invention includes a display 100 for displaying images, a shutter member 60 which may be a pair of shutter glasses, and various controllers for controlling them. The display 100 may be various displays such as a plasma display panel (PDP), a liquid crystal display (LCD), an organic light emitting diode display (OLED), etc. Hereinafter, a liquid crystal display will be described as an example.

The display 100 according to the exemplary embodiment of the present invention includes a display panel 300, a gate driver 400 and a data driver 500 connected to the display panel 300, a gray scale voltage generator 800 connected to the data driver 500, a signal controller 600 for controlling them, and a backlight unit 900 for supplying light to the display panel 300.

The display panel 300 includes a plurality of display signal lines and a plurality of pixels, represented by the equivalent circuit PX, that are connected to the plurality of display signal lines and generally arranged in a matrix as shown. The display signal lines include a plurality of gate lines GL1 to GLn for transmitting gate signals (referred to as ‘scan signals’) and a plurality of data lines DL1 to DLm for transmitting data signals. Each pixel PX may include a switching element Q such as a thin film transistor, with a liquid crystal capacitor Clc and a storage capacitor Cst connected thereto. The switching element Q may be connected to a corresponding gate line (GL1, . . . , GLn) and a corresponding data line (DL1, . . . DLm). The liquid crystal capacitor Clc uses, as two terminals, a pixel electrode (not shown) of a lower display panel to which a data voltage is applied from the corresponding data line (DL1, . . . , DLm) and an opposite electrode (not shown) of an upper panel. A liquid crystal layer interposed between the two electrodes functions as a dielectric material. The storage capacitor Cst plays an auxiliary role for the liquid crystal capacitor Clc, and thus may be omitted.

The gate driver 400 is connected to the gate lines GL1 to GLn, and applies gate signals, composed of a combination of a gate-on voltage Von and a gate-off voltage Voff, to the gate lines GL1 to GLn.

The gray scale voltage generator 800 generates gray scale reference voltages, including voltages having positive values and negative values with respect to a common voltage Vcom.

The data driver 500 is connected to the data lines DL1 to DLm of the display panel 300, and divides the gray scale reference voltages from the gray scale voltage generator 800 to generate gray scale voltages along the entire gray scale, and selects data voltages from among them.

The signal controller 600 controls the operations of the gate driver 400, the data driver 500, etc.

The backlight unit 900 includes a light source, and examples of the light source include a fluorescent lamp such as a CCFL (cold cathode fluorescent lamp), a LED (light emitting diode), etc. Moreover, the backlight unit may further include a reflector, a light guide plate, a luminance improvement film, etc.

The shutter member 60 is synchronized with the display 100 to generate images displayed on the display 100 that are perceived as 3D images (as above).

The controller for controlling the display 100 and the shutter member 60 includes a luminance controller 950 and a stereo controller 650.

The stereo controller 650 receives image information DATA from an external source, and generates an input image signal IDAT, a 3D enable signal 3D_En, a 3D timing signal, a 3D sync signal 3D_sync, and an input control signal CONT1 for controlling the display of the input image signal IDAT.

The stereo controller 650 may transmit the generated 3D timing signal and 3D enable signal 3D_En to the luminance controller 950. The luminance controller 950 may generate a backlight control signal on the basis of the received 3D timing signal and 3D enable signal 3D_En, and transmit the backlight control signal to the backlight unit 900. The backlight unit 900 may be turned on or off according to the backlight control signal from the luminance controller 950. The backlight control signal may switch the backlight unit to an ON state during a predetermined time period. For example, the backlight control signal transmitted to the backlight unit may enable the backlight unit to emit light during a vertical blank period VB or a time period other than the vertical blank period VB. The vertical blank period VB will be described below.

The stereo controller 650 may transmit the generated 3D sync signal 3D_sync to the shutter member 60. The shutter member 60 is electrically connected to the stereo controller 650 by any method, and may receive the 3D sync signal 3D_sync by various such communication methods, e.g. a wireless infrared communication method. The shutter member 60 may operate in response to the 3D sync signal 3D_sync, or to a modification of the 3D sync signal 3D_sync. When the shutter member 60 is a pair of shutter glasses, the 3D sync signal 3D_sync may include all signals to open or close a left eye shutter and/or a right eye shutter of the shutter glasses. The shutter member 60 is described below in further detail.

Meanwhile, the stereo controller 650 outputs the input image signal IDAT, the 3D enable signal 3D_En, and the input control signal CONT1 to the signal controller 600. The input control signal CONT1 may include a vertical sync signal Vsync, a horizontal sync signal Hsync, a main clock MCLK, a data enable signal DE, etc. The signal controller 600 appropriately processes the input image signal IDAT on the basis of the input image signal IDAT and the input control signal CONT1, to satisfy the operational conditions of the display panel 300. The signal controller 600 then generates a gate control signal CONT2, a data control signal CONT3, and a gray scale voltage control signal CONT4, outputs the gate control signal CONT2 to the gate driver 400, outputs the data control signal CONT3 and the processed image signal DAT to the data driver 500, and outputs the gray scale voltage control signal CONT4 to the gray scale voltage generator 800.

According to the data control signal CONT3 from the signal controller 600, the data driver 500 receives a digital image signal DAT for pixels PX in one row, converts the digital image signal DAT into data voltages Vds by selecting gray scale voltages (corresponding to each digital image signal DAT) from the gray scale reference voltages received from the gray scale voltage generator 800, and applies each data voltage Vd to a corresponding data line (DL1 to DLm).

The gate driver 400 applies the gate-on voltage Von to a gate line (GL1 to GLn) according to the gate control signal CONT2 from the signal controller 600, so as to turn on the switching element Q connected to the corresponding gate line (GL1 to GLn). Accordingly, the data voltage Vd applied to a data line (DL1 to DLm) is applied to a corresponding pixel PX through the switched-on element Q.

If a data voltage Vd is applied to the pixel electrode of the liquid crystal capacitor Clc, the voltage difference between the pixel electrode and the opposite electrode (to which the common voltage Vcom is applied) is referred to as a pixel voltage of each pixel PX, and liquid crystal molecules in the liquid crystal layer interposed between the two electrodes are oriented according to this pixel voltage. The degree of polarization of light penetrating the liquid crystal layer varies according to the orientation of the liquid crystal molecules, which enables the pixel PX to display a luminance corresponding to the gray scale of the input image signal IDAT.

This process is repeated every one horizontal period (which is written ‘1H’ and is the same as one period of the data enable signal DE and the horizontal sync signal Hsync) so as to sequentially apply the gate-on voltage Von to all gate lines GL1 to GLn, and apply the data voltages Vd to all pixels PX, thereby displaying one frame of image.

Referring to FIGS. 1 and 2, the direction of the dotted arrows shown in the display 100 represents the order in which the gate-on voltage Von is applied to the plurality of columnar gate lines GL1 to GLn (i.e., the gate lines substantially extend in a column direction, and Von is sequentially applied from top to bottom of a column). That is, the gate-on voltage Von may be sequentially applied to the first gate line GL1 to the last gate line GLn of the display 100.

For example, the display 100 may display the left eye image (101, 102) as follows. The gate-on voltage Von is sequentially applied to the gate lines GL1 to GLn to enable the data voltages Vd to be applied to the pixel electrodes through switching elements Q such as thin film transistors connected to the corresponding gate lines GL1 to GLn. In this case, the applied data voltages Vd are data voltages for displaying the left eye image (101, 102) (hereinafter, referred to as left eye data voltages) and the applied left eye data voltages may be maintained by the storage capacitors Cst during a predetermined period. Similarly, data voltages for displaying the right eye image (101′, 102′) (hereinafter, referred to as right eye data voltages) are applied and may be maintained by the storage capacitors Cst during a predetermined period.

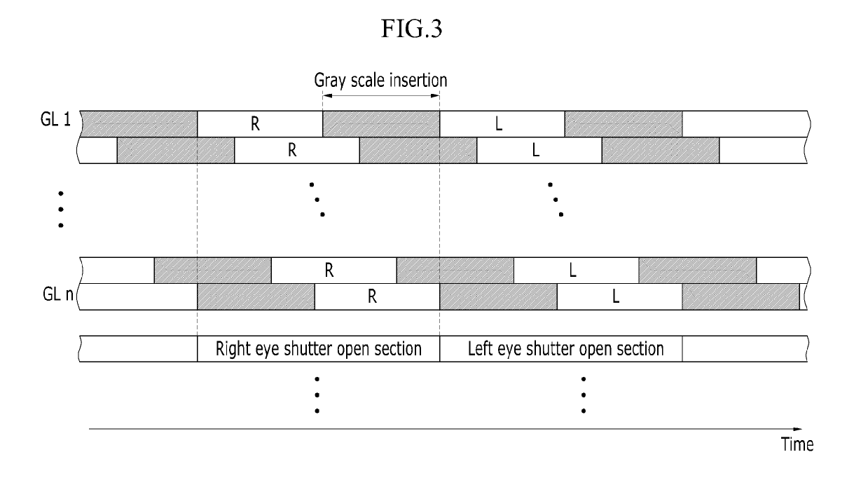

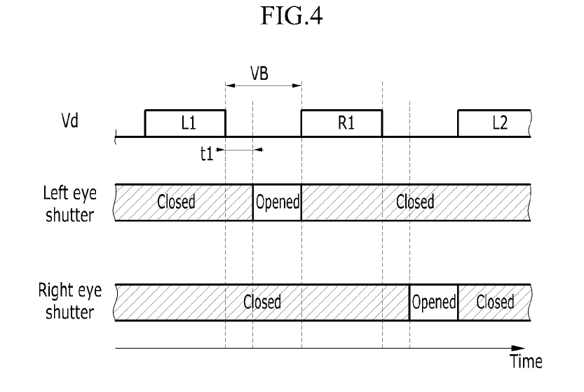

Now, a driving method of such a 3D image display system will be described with reference to FIGS. 3 and 4, together with FIGS. 1 and 2 as described above.

FIG. 3 is a graph illustrating a driving method of a 3D image display system according to an exemplary embodiment of the present invention, and FIG. 4 is a graph illustrating a driving method of a 3D image display system according to another exemplary embodiment of the present invention.

First, referring to FIG. 3, the gate-on voltage Von may be sequentially applied to gate lines GL1 to GLn such that a right eye image R is sequentially applied to a plurality of pixels PX connected to a corresponding gate line (GL1, . . . , GLn), followed by a left eye image L that is sequentially applied to a plurality of pixels PX connected to a corresponding gate line (GL1, . . . , GLn). Here, while the right eye image R is sequentially applied to the plurality of pixels PX connected to the corresponding gate line (GL1, . . . , GLn), the right eye shutter is in an opened state and the left eye shutter is in a closed state. Later, the left eye image L is sequentially applied to the plurality of pixels PX connected to the corresponding gate line (GL1, . . . , GLn), where the left eye shutter mis in an opened state and the right eye shutter is in a closed state. That is, the left eye shutter and the right eye shutter are alternately opened and closed, and when the right eye shutter is open, the right eye image R is displayed, while when the left eye shutter is open, the left eye image L is displayed.

An image having a predetermined gray scale value may be displayed between the sections of the right eye image R and the left eye image L, which is referred to as gray scale insertion. For example, after the right eye image R is displayed on the display 100, a black, white, or predetermined-gray-scale image on the entire screen may be displayed and then the left eye image L may be displayed. Here, the predetermined gray scale is not limited to black or white, but may have various values. If the image having the predetermined gray scale is inserted to be displayed on the entire screen of the display panel 300 of the display 100, cross-talk between the right eye image and the left eye image can be prevented.

Next, referring to FIG. 4, the left eye data voltages (L1, L2, . . . ) and the right eye data voltages (R1, . . . ) are applied to the data lines DL1 to DLm. Note that there are time periods between input of left eye data voltage Ln and right eye data voltage Rn, during which no data voltage is input. These time periods are referred to as vertical blank periods VB. During at least a part of a vertical blank period VB, any one of the left eye shutter (31, 31′) and the right eye shutter (32, 32′) of the shutter glasses 30 is closed, and the other is maintained in an opened state. In FIG. 4, hatched portions of graphs illustrating states of the left eye shutter and the right eye shutter indicate a closed state. In the sections in which the left eye data voltages (L1, L2, . . . ) or the right eye data voltages (R1, . . . ) are input, both of the left eye shutter (31, 31′) and the right eye shutter (32, 32′) of the shutter glasses 30 is in the closed state.

If a predetermined time period t1 elapses after a left eye data voltage (L1, L2, . . . ) or a right eye data voltage (R1, . . . ) is input, the left eye shutter (31, 31′) or the right eye shutter (32, 32′) is actuated from the closed state to the opened state. The predetermined time period t1 may be determined on the basis of the response time of the display 100. For example, when the display is a liquid crystal display, due to the response time of liquid crystal, a predetermined time period is required until the right eye image (101′, 102′) shown in FIG. 1 is output after the input of the right eye data voltage R1 is completed. Therefore, after the predetermined time period t1 elapses, the right eye shutter (32, 32′) is opened. In this manner, the complete right eye image (101′, 102′) can be perceived, and cross-talk by the previous image can be prevented.

Now, shutter glasses according to an exemplary embodiment of the present invention will be described with reference to FIGS. 5 to 7 together with the exemplary embodiments described above.

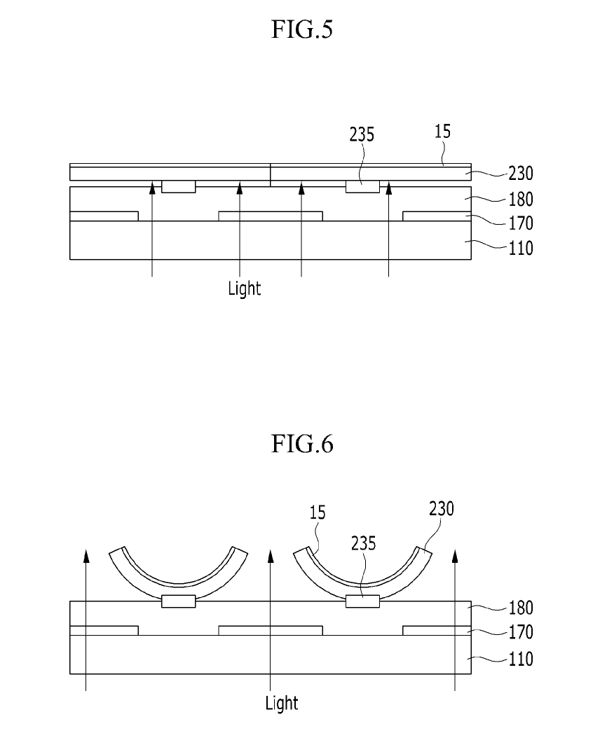

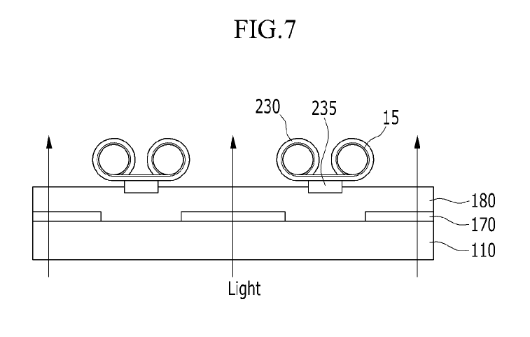

FIG. 5 is a cross-sectional view illustrating the cross-sectional structure of shutter glasses according to an exemplary embodiment of the present invention, in which shutters are in a closed state. FIG. 6 is a cross-sectional view illustrating the cross-sectional structure of shutter glasses according to an exemplary embodiment of the present invention in which shutters are in an opened state. FIG. 7 is a cross-sectional view illustrating the cross-sectional structure of shutter glasses according to another exemplary embodiment of the present invention, in which shutters are in an opened state.

Shutter glasses according to an exemplary embodiment of the present invention may be shutter glasses using MEMS elements formed on an insulation substrate 110. MEMS elements exhibit relatively rapid response speed, and are thus capable of quickly responding to signals of a display. Therefore, MEMS elements are very useful for synchronization with a display.

A plurality of control electrodes 170 are formed on the insulation substrate 110 and a passivation layer 180 is formed thereon. The passivation layer 180 can be formed of, for example, an organic insulator or an inorganic insulator. The control electrodes 170 may be made from a transparent conductive layer, and can transmit light from the display 100. The control electrodes 170 may receive signals through wiring lines (not shown) formed on the insulation substrate 110.

A plurality of fixed electrodes 235 and shutters 230 connected thereto are sequentially formed on the passivation layer 180.

The shutters 230 may be formed of a light-blocking material so as to block out light from the display 100, and may be formed of a material suitable for opening and closing by an electrostatic force. Alternatively, the shutters 230 may be formed of a plurality of layers having different expansion coefficients, so as to be opened or closed via the generation of heat. For example, the shutters 230 may be formed of a metal material having conductivity, such as molybdenum (Mo) or copper (Cu).

The fixed electrodes 235 are electrically connected to the shutters 230 and transfer signals to the shutters 230. The shutters 230 are formed such that when the shutters 230 are opened or closed, portions of the shutters 230 connected to the fixed electrodes 235 are fixed and the remaining portions move. In the present exemplary embodiment, the fixed electrodes 235 are formed substantially at the centers of the shutters 230. However, each of the fixed electrodes 235 may alternatively be positioned at one end of a corresponding shutter 230.

When the shutters 230 are in the closed state as shown in FIG. 5, light cannot penetrate the shutters to the upper side, and when the shutters 230 are in the opened state as shown in FIG. 6, light penetrates the shutters to the upper side.

Both side portions of each of the shutter 230 may be pushed up (i.e. opened), or be brought into close contact with the passivation layer 180 (i.e. closed), by the electrostatic force caused by a voltage difference between the control electrodes 170 and the corresponding shutter 230, such that the corresponding shutter is opened or closed. That is, the shutters 230 actuate by either deforming into a generally arcuate shape (each end curling upward and toward a center portion) or straightening out (each end uncurling so that the shutter 230 lies generally straight/flat, with the ends generally coplanar with the middle).

The degree of open of each shutter 230 may be adjusted according to the electrostatic force (i.e., the amount of applied voltage). The shutters 230 may be formed to have a thickness enabling the shutters to be easily pushed up by the electrostatic force. For example, the shutters may be formed to have a thickness equal to or less than 2 um.

Antireflective layers 15 may be formed on the top surfaces of the shutters 230. The antireflective layers 15 may be formed of light absorption layers. For example, in the present exemplary embodiment, oxide layers may be formed on the surfaces of the shutters 230, thereby preventing reflection. When the antireflective layers are formed of oxide layers, no photolithography process for forming separate layers is needed, resulting in reduced process time and expense. For example, oxide layers may be simply formed, without an additional photolithography, by a method of performing ashing on the shutter 230 using oxygen in a dry process, or a method of performing surface treatment on the shutter 230 by using nitric acid, sulfuric acid, or hydrogen peroxide in a wet process. The surfaces of the shutters 230 are oxidized by the above-mentioned methods to generate oxide layers at the surfaces, and the oxide layers may function as the antireflective layers 15.

When the shutters 230 are in the closed state as shown in FIG. 5, the antireflective layers 15 prevent reflection of external light, reducing blurriness and increasing contrast ratio CR.

Further, even when the shutters 230 are in the opened state as shown in FIG. 6, the antireflective layers 15 prevent external light from being reflected from the shutters 230, preventing clarity of images from being degraded.

If necessary, antireflective layers (not shown) may be formed on the bottom surfaces of the shutters 230 as well.

Meanwhile, FIG. 7 shows another exemplary embodiment of shutters 230, in which shutters 230 are shown in their open state. The present exemplary embodiment has a structure in which both side portions of each of the shutters 230 are opened by rolling up. In the present exemplary embodiment, antireflective layers 15 are formed on the top surfaces of the shutters 230. That is, the shutters 230 actuate by either rolling up (each end curling toward a center portion) or straightening out (each end uncurling so that the shutter 230 lies generally straight/flat, with the ends generally coplanar with the middle).

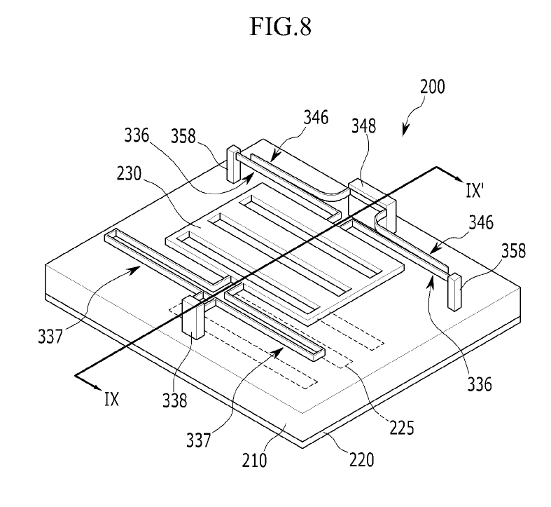

As described above, in the 3D image display system, the shutters of the shutter glasses are formed by using MEMS elements configured for rapid response, making it relatively easy to synchronize the display with various signals. Next, shutter glasses according to another exemplary embodiment of the present invention will be described with reference to FIGS. 8 to 10. The same constituent elements as those in the exemplary embodiments described above are denoted by identical reference symbols, and a description thereof will be omitted.

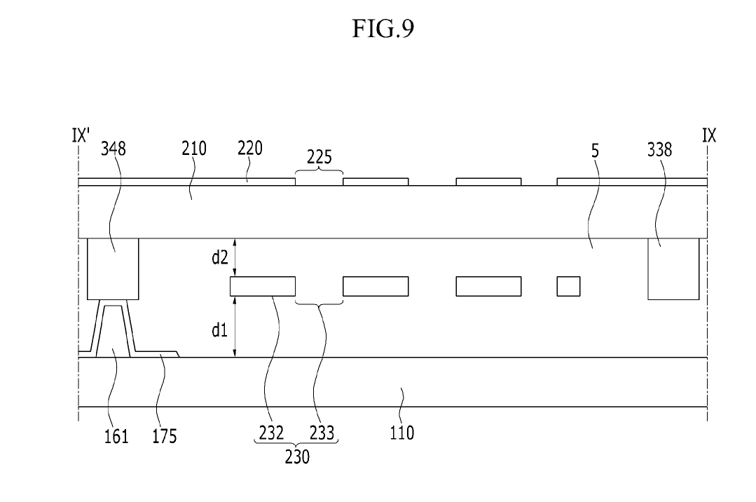

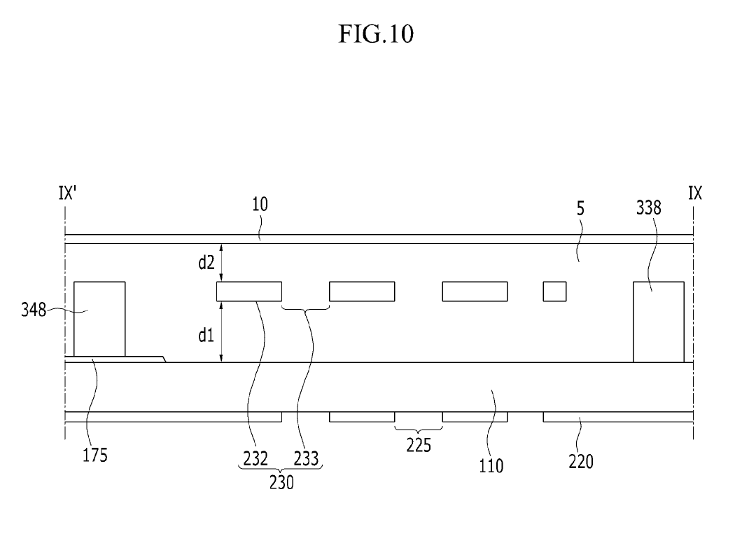

FIG. 8 is a drawing illustrating a layout of a first substrate of shutter glasses according to an exemplary embodiment of the present invention. FIG. 9 is a cross-sectional view of the shutter glasses shown in FIG. 8 as taken along a line IX-IX′, and FIG. 10 is another example of the cross-sectional view of the shutter glasses shown in FIG. 8 as taken along the line IX-IX′.

The shutter glasses according to the present exemplary embodiment also use MEMS elements configured for rapid response, and include two substrates 110 and 210 with MEMS elements formed therebetween.

Referring to FIG. 9, a protrusion 161 having a height of about dl is formed the transparent insulation substrate 110, and a control electrode 175 is formed thereon. The control electrode 175 may be formed through a photolithography process after a conductive material is applied. The protrusion 161 may be omitted.

On another insulation substrate 210, there is formed a light blocking unit 200 (refer to FIG. 8) that controls light transmission by the mechanical operation of MEMS elements. The light blocking unit 200 is largely formed on one surface of the insulation substrate 210, and includes an aperture plate 220 and a shutter unit formed on another surface of the insulation substrate 210. More specifically, the aperture plate 220 may be formed on the outside surface of the insulation substrate 210, and the shutter unit may be formed on the surface of the insulation substrate 210 facing the insulation substrate 110.

The aperture plate 220 may be formed of an opaque material, and includes a plurality of openings 225 through which light can penetrate. An absorption layer (not shown) capable of suppressing reflection of external light may be applied on the outer surface of the aperture plate 220, and a reflective layer (not shown) capable of reflecting light may be applied to a surface of the aperture plate 220 brought into contact with the insulation substrate 210.

Referring to FIGS. 8 and 9, the shutter unit includes a shutter 230, an electrode unit (348, 346, 336) capable of moving the shutter 230 by an electrical attraction or repulsion, and a restoring unit 337 for moving the shutter 230 back to its original position.

The shutter 230 may include a light blocking unit 232 having general plate shapes, and a plurality of openings 233 between the plate shapes. The openings 233 may be formed to have the same shape and size as the openings 225 of the aperture plate 220. The shutter 230 may be positioned away from the insulation substrate 210 by an interval d2 for smooth horizontal movement.

The electrode unit (348, 346, 336) may be composed of conductive members including a first support beam 348 formed on the insulation substrate 210, flexible beams 346 connected to the first support beam 348, and connection beams 336 spaced apart from the flexible beams 346 by a predetermined interval. The first support beam 348 may be in contact with the control electrode 175. Therefore, signals applied to the control electrode 175 may be transmitted to the flexible beams 346 through the first support beam 348, so that the control electrode 175 controls openings/closings of the shutter 230. Since the shutter 230 is positioned apart from the insulation substrate 110 by the control electrode 175 at an interval d1, it can move unimpeded in a horizontal direction. Further, in order to make the movement of the shutter 230 smooth, a gap between the two substrates 110 and 210 may be filled with a fluid such as oil or some other fluid having suitable viscosity. Alternatively, the space 5 may be empty, or filled by ambient air.

One end of each of the flexible beams 346 is fixed to a first support beam 348, and the other end of the corresponding flexible beam 346 may extend from the first support beam 348 in a general bow shape, where the other end is unconstrained (i.e., unattached to another structure) and can freely move. In other words, each flexible beam 346 has a first portion that extends from its first support beam 348 initially in a first direction, a second portion that extends in a second direction generally perpendicular to the first direction and having a generally unconstrained end, and a third portion connecting the first and second portions.

One end of each of the connection beams 336 is connected to the shutter unit, and the other end of the corresponding connection beam 336 is fixed to a second support beam 358 provided on the insulation substrate 210 such that the shutter 230 can be floated away from the insulation substrate 210 by a predetermined interval. A predetermined voltage may be applied to the second support beam 358.

The restoring unit 337 is formed in a general cross shape to have elasticity. One end of the restoring unit 337 is connected to the shutter 230, and the other end of the restoring unit 337 is in contact with a third support beam 338. The restoring unit 337 functions as a spring and is formed in the cross shape in the present exemplary embodiment. However, the restoring unit can be fabricated in any shape that produces sufficient elasticity or compliance.

The other ends of the flexible beams 346 push the connection beams 336 by an electrical force caused by a voltage applied to the flexible beams 346 through the first support beam 348 and a predetermined voltage applied to the connection beams 336 through the second support beams 358. Depending on the difference between the two applied voltages, the connection beams 336 are either attracted to or repelled from the flexible beams 346, thereby moving the shutter 230. If the connection beams 336 are repelled from the flexible beams 346, the shutter 230 is moved away from the flexible beams 346. In this case, the restoring unit 337 produces a restoring force countering the repulsive electrical force, maintaining the shutter 230 in a particular position. When there is no voltage difference between the flexible beams 346 and the connection beams 336, the shutter 230 moves to its original position due to the restoring force of the restoring unit 337.

As such, it is possible to adjust the positions of the openings 233 by moving the shutter 230 horizontally. The positions of the openings 233 of the shutter 230 may be aligned with the positions of the openings 225 of the aperture plate 220 such that the shutter glasses enter an opened state. Alternatively, the shutter 230 may move to a position in which the openings 233 of the shutter 230 are not aligned with the openings 225, so that the shutter glasses enter a closed state. Next, referring to FIG. 10, the shutter glasses using MEMS elements according to the present exemplary embodiment are similar to the exemplary embodiment shown in FIGS. 8 and 9. However, the aperture plate 220 is instead positioned on the bottom surface of the insulation substrate 110, and the upper insulation substrate 210 is omitted. Instead of omitting the upper insulation substrate 210, an overcoat 10 may cover the upper portion of a space 5 where the shutter unit is formed. The overcoat 10 may be formed of, for example, a PET film, and may act to seal the space 5.

Further, in the present exemplary embodiment, the electrode unit (348, 346, 336) may be formed on the insulation substrate 110, and the protrusion 161 may also be omitted.

As such, if one of two substrates 110 and 210 is omitted and the aperture plate 220 is positioned on one surface of the other substrate, it is possible to reduce the thickness of the shutter glasses.

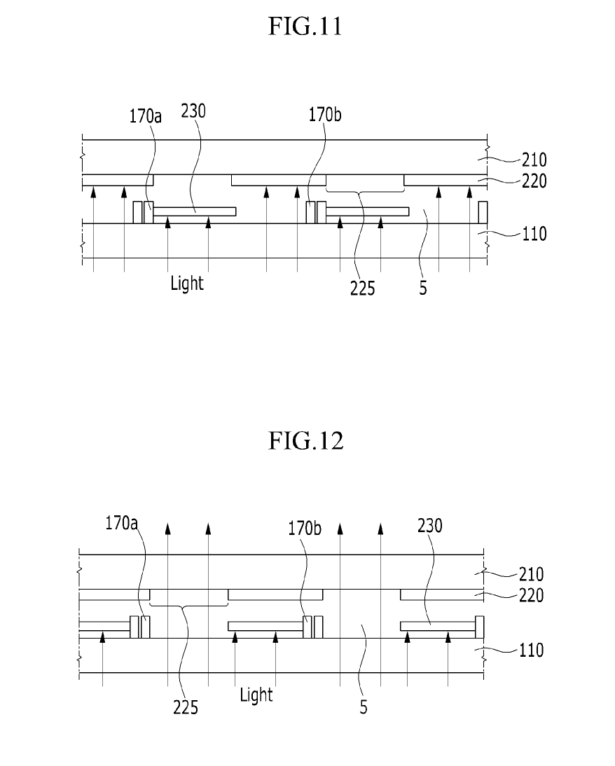

Next, shutter glasses according to another exemplary embodiment of the present invention will be described with reference to FIGS. 11 to 13. The same constituent elements as those in the exemplary embodiments described above are denoted by identical reference symbols, and a description thereof will be omitted.

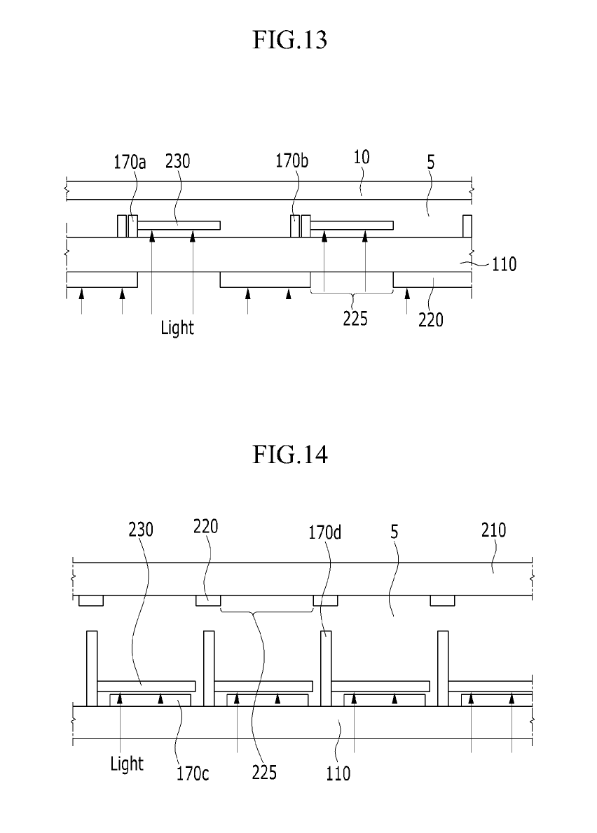

FIG. 11 is a cross-sectional view of shutter glasses in which openings have been closed by shutters. FIG. 12 is a cross-sectional view of shutter glasses in which openings have been opened by shutters, and FIG. 13 is a cross-sectional view of shutter glasses with closed shutters constructed according to an alternative embodiment.

Shutter glasses constructed according to this exemplary embodiment include two substrates 110 and 210 facing each other, and MEMS elements formed between two substrates 110 and 210. A space 5 between the two substrates 110 and 210 may be filled with a fluid such as oil or a gas having suitable viscosity.

The MEMS elements may include an aperture plate 220, shutters 230, first control electrodes 170a, and second control electrodes 170b.

The aperture plate 220 is formed of a light-blocking material, and is formed on the inside surface of the substrate 210 (i.e., facing the opposite substrate 110). The aperture plate 220 has a plurality of openings 225 though which light can penetrate. The openings 225 may be disposed at predetermined intervals.

The first control electrodes 170a and the second control electrodes 170b may be formed on the substrate 110. Each of the first control electrodes 170a is paired with one second control electrode 170b and the pairs are disposed at predetermined intervals. Further, the first control electrodes 170a and the second control electrodes 170b may be positioned outside the boundaries of the openings 225 of the aperture plate 220. For example, the first control electrodes 170a may be positioned at or close to the boundaries of the openings 225, and the second control electrodes 170b may be positioned beside the first control electrodes 170a. Voltages may be applied to the first control electrodes 170a and the second control electrodes 170b.

The shutters 230 may have a shape and an area capable of substantially covering the openings 225 of the aperture plate 220, and may be formed of a material which does not transmit light. The shutters 230 are positioned between the first control electrodes 170a and the second control electrodes 170b, and can move or slide left and right to cover or open corresponding openings 225. The shutters 230 may be connected to a support unit (not shown) for supporting the shutters 230 and enabling the shutters 230 to move left and right from a reference position. Similar to the restoring unit 337 of FIG. 8, the support unit may have a shape of, for example, a plate spring or a bendable spring to have an elastic force enabling the shutters 230 having moved left or right to be restored to original positions.

The individual shutters 230 may be separate from each other, or alternatively two or move shutters 230 may be connected to each other. A common voltage Vcom may be applied to the shutters 230.

One opening 225, one shutter 230 corresponding thereto, and a pair of first and second control electrodes 170a and 170b positioned on both sides of the one shutter 230 collectively form one MEMS element.

Now, an example of the operation of such a MEMS element will be described.

First, referring to FIG. 11, a predetermined voltage such as the common voltage Vcom is applied to the shutter 230 and the second control electrode 170b and a voltage different from the predetermined voltage is applied to the first control electrode 170a. The voltage applied to the first control electrode 170a may be positive or negative with respect to the common voltage Vcom. Attractive forces between the shutter 230 and the first control electrode 170a due to the difference between the voltage of the shutter 230 and the voltage of the first control electrode 170a will move the shutter 230 toward the first control electrode 170a. In this manner, the shutter 230 will substantially cover, or overlie, its corresponding opening 225 such that a left eye shutter or a right eye shutter of the shutter glasses is placed in a closed state.

Next, referring to FIG. 12, a predetermined voltage such as the common voltage Vcom is applied to the shutter 230 and the first control electrode 170a, and a voltage different from the predetermined voltage is applied to the second control electrode 170b. The voltage applied to the second control electrode 170b may be positive or negative relative to the predetermined voltage. Attractive forces between the shutter 230 and the second control electrode 170b due to the difference between the voltage of the shutter 230 and the voltage of the second control electrode 170b move the shutter 230 toward the second control electrode 170b. In this manner, the shutter 230 opens the corresponding opening 225 such that a left eye shutter or a right eye shutter of the shutter glasses enters an opened state. In other words, the voltages applied to the electrodes 170c, d and shutter 230 are reversed to place the shutter 230 in its open state.

The exemplary embodiment shown in FIG. 13 is similar to the embodiment shown in FIGS. 11 and 12. However, the aperture plate 220 is positioned on the bottom surface of the insulation substrate 110 and the upper insulation substrate 210 is omitted. Instead, an overcoat 10 may cover the upper portion of space 5. The overcoat 10 may be formed of, for example, a PET film, and serve the function of sealing the space 5.

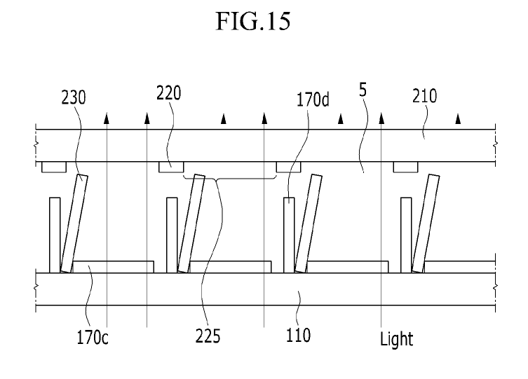

Finally, shutter glasses according to another exemplary embodiment of the present invention will be described with reference to FIGS. 14 and 15. The same constituent elements as those in the exemplary embodiments described above are denoted by identical reference symbols, and a description thereof will be omitted.

FIG. 14 is a cross-sectional view of shutter glasses according to another exemplary embodiment of the present invention in which openings have been closed by shutters, and FIG. 15 is a cross-sectional view of shutter glasses according to another exemplary embodiment of the present invention in which openings have been opened by shutters.

Shutter glasses configured according to an exemplary embodiment of the present invention include two substrates 110 and 210 facing each other, with MEMS elements formed therebetween.

The MEMS elements may include an aperture plate 220, shutters 230, first control electrodes 170c, and second control electrodes 170d.

The aperture plate 220 is formed on the insulation substrate 210, and includes a plurality of openings 225.

The first control electrodes 170c and the second control electrodes 170d may be formed on the insulation substrate 110. The first control electrodes 170c may be formed on the substrate 110 such that the long sides (extension direction) of the first control electrodes 170c are generally parallel with the surface of the lower substrate 110 and may be arranged to have the substantially same pitch as the openings 225. The second control electrodes 170d may be erected on the substrate 110 such that the long sides (extension direction) of the second control electrodes 170d are vertical to the surface of the lower substrate 110 and may be arranged to have the substantially same pitch as the openings 225. That is, the first control electrodes 170c and the second control electrodes 170d are substantially perpendicular to each other and are alternately disposed. Further, the first control electrodes 170c may face the openings 225 of the aperture plate 220 and the second control electrodes 170d may face portions of the aperture plate 220 where the openings 225 are not positioned. That is, the first control electrodes 170c are placed in the openings 225, and the second control electrodes 170d are placed between the openings 225.

The shutters 230 may have a shape and an area capable of substantially covering the openings 225 of the aperture plate 220. The shutters 230 are positioned between the first control electrodes 170c and the second control electrodes 170d, and can pivot between the first control electrodes 170c and the second control electrodes 170d on pivot points (not shown) positioned approximately at the locations where the second control electrodes 170d meet the lower substrate 110. That is, the shutters 230 can pivot so as to change the degree to which the openings 225 are covered, as they are hinged to the lower substrate 110.

The shutters 230 may be connected to a support unit (not shown) allowing the shutters to pivot to predetermined reference positions, and the support unit may have an elastic force that tends to restores the shutters 230 to their original positions in the absence of other forces.

One opening 225, one shutter 230 corresponding thereto, and first and second control electrodes 170c and 170d determining the swing width of the one shutter 230 collectively form one MEMS element.

Now, an example of the operation of such a MEMS element will be described.

First, referring to FIG. 14, a predetermined voltage such as the common voltage Vcom is applied to the shutter 230 and the second control electrode 170d, and a voltage different from the predetermined voltage is applied to the first control electrode 170c. The voltage applied to the first control electrode 170c may be positive or negative relative to the common voltage Vcom. Attractive forces between the shutter 230 and the first control electrode 170c due to the difference between the voltage of the shutter 230 and the voltage of the first control electrode 170c move the shutter 230 toward the first control electrode 170c. The shutter 230 thus pivots down upon the first control electrode 170c, substantially covering the corresponding opening 225 such that the shutter of the shutter glasses enters a closed state.

Next, referring to FIG. 15, the predetermined voltage is applied to the shutter 230 and the first control electrode 170c, and a voltage different from the predetermined voltage is applied to the second control electrode 170d. The voltage applied to the second control electrode 170d may be positive or negative relative to the common voltage Vcom. Attractive forces between the shutter 230 and the second control electrode 170d due to the difference between the voltage of the shutter 230 and the voltage of the second control electrode 170d move the shutter 230 toward the second control electrode 170d. Therefore, the shutter 230 pivots substantially parallel to the second control electrode 170d, substantially opening the corresponding opening 225. In this manner, the shutter of the shutter glasses enters its opened state. In other words, the voltages applied to the electrodes 170c, d and shutter 230 are reversed to place the shutter 230 in its open state.

Shutter glasses for a 3D image display system according to exemplary embodiments of the present invention are not limited to the structures of the MEMS elements according to various exemplary embodiments described above, but may be formed by using MEMS elements having various structures.

Since shutters of shutter glasses used for a 3D image display system are formed by using MEMS elements configured as in an exemplary embodiment of the present invention, it is possible to reduce the thickness and weight of shutter glasses, thereby improving usability. Further, since the response speed of shutter glasses can be increased, it becomes easier to synchronize the display with various signals.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 5: Space | 10: Overcoat |
| 15: Antireflective layers | 30: Shutter glasses |
| 31, 31′: Left eye shutter | 32, 32′: Right eye shutter |
| 100: Display | 101, 102: Left eye image |
| 101′, 102′: Right eye image | 110, 210: Substrate |
| 170, 175, 170a, 170b: Control electrode | 180: Passivation layer |
| 200: Light blocking unit | 220: Aperture plate |
| 225, 233: Opening | 230: Shutter |
| 235: Fixed electrode | 300: Display panel |
| 336, 346, 348: Electrode unit | 337: Restoring unit |
| 400: Gate driver | 500: Data driver |
| 600: Signal controller | 650: Stereo controller |
| 800: Gray scale voltage generator | 900: Backlight unit |
| 950: Luminance controller | |

What is claimed is:

1. Shutter glasses for a 3D image display, the shutter glasses comprising:
a left eye shutter and a right eye shutter,
wherein at least one of the left eye shutter and the right eye shutter includes a MEMS element controlling an opening and a closing of the at least one of the left eye shutter and the right eye shutter.

2. The shutter glasses for a 3D image display of claim 1, wherein the MEMS element includes:
a control electrode formed on a substrate, and
a shutter formed in electrical communication with the control electrode and capable of being opened and closed.

3. The shutter glasses of claim 2, further comprising:
an antireflective layer formed on a top surface of the shutter.

4. The shutter glasses of claim 3, further comprising:
a fixed electrode configured to fix the shutter and apply signals to the shutter.

5. The shutter glasses of claim 1, wherein the MEMS element includes:
an aperture plate formed of a light-blocking material and having at least one opening, and
a shutter configured to prevent light from passing through the opening.

6. The shutter glasses of claim 5, further comprising:
a control electrode configured to control a position of the shutter.

7. The shutter glasses of claim 6, further comprising:
a first substrate and a second substrate facing each other, with the MEMS element interposed therebetween,
wherein wiring lines are formed on the first substrate, the wiring lines being connected to the control electrodes so as to apply signals to the control electrodes, and
wherein the aperture plate is formed on the second substrate.

8. The shutter glasses of claim 6, further comprising:
a first substrate and a second substrate facing each other, with the MEMS element interposed therebetween,
wherein wiring lines are formed on a first surface of the first substrate, the wiring lines being connected to the control electrodes so as to apply signals to the control electrodes, and
wherein the aperture plate is formed on a second surface of the first substrate, the second surface being opposite to the first surface.

9. The shutter glasses of claim 6, wherein the shutter has a first position when a signal is not applied to the control electrode and a second position when the signal is applied to the control electrode, the shutter glasses further comprising:
a restoring unit configured to provide a restoring force returning the shutter to the first position.

10. The shutter glasses of claim 2, wherein:
the shutter has opposite first and second ends and a middle portion therebetween, and
when the shutter is closed, the first and second ends are generally coplanar with the middle portion, and when the shutter is opened, the first and second ends are each deformed toward the middle portion and away from the substrate, so as to form a generally arcuate shape.

11. The shutter glasses of claim 2, wherein:
the shutter has opposite first and second ends and a middle portion therebetween, and
when the shutter is closed, the first and second ends are generally coplanar with the middle portion, and when the shutter is opened, the first and second ends are each deformed toward the middle portion and away from the substrate, so as to form a generally curled shape.

12. The shutter glasses of claim 2, wherein:
an end of the shutter is slidably coupled to the control electrode, the shutter sliding between an opened position and a closed position according to a voltage applied to the control electrode.

13. The shutter glasses of claim 2, wherein:
an end of the shutter is pivotably attached to at least one of the control electrode and the substrate, the shutter pivoting between an opened position and a closed position according to a voltage applied to the control electrode.

14. A 3D image display system comprising:
a display configured to alternately display left eye images and right eye images; and
shutter glasses including a left eye shutter and a right eye shutter,
wherein at least one of the left eye shutter and the right eye shutter includes a MEMS element controlling an opening and a closing of the at least one of the left eye shutter and the right eye shutter.

15. The 3D image display system of claim 14, wherein the MEMS element includes:
a control electrode formed on a substrate, and
a shutter formed on the control electrode and capable of being opened and closed.

16. The 3D image display system of claim 14, wherein:
the MEMS element actuates the shutter in response to a synchronization signal from the display.

17. The 3D image display system of claim 16, wherein:
the left eye shutter and the right eye shutter are actuated so as to be opened in an alternating manner.

18. The 3D image display system of claim 14, wherein the MEMS element includes:
an aperture plate formed of a light-blocking material and having at least one opening, and
a shutter configured to prevent light from passing through the opening.

19. The 3D image display system of claim 18, further comprising:
a control electrode configured to control a position of the shutter.

20. The 3D image display system of claim 19, further comprising:
a first substrate and a second substrate facing each other, with the MEMS element interposed therebetween,
wherein wiring lines are formed on the first substrate, the wiring lines being connected to the control electrodes so as to apply signals to the control electrodes, and
wherein the aperture plate is formed on the second substrate.

21. The 3D image display system of claim 19, further comprising:
a first substrate and a second substrate facing each other, with the MEMS element interposed therebetween,
wherein wiring lines are formed on a first surface of the first substrate, the wiring lines being connected to the control electrodes so as to apply signals to the control electrodes, and
wherein the aperture plate is formed on a second surface of the first substrate, the second surface being opposite to the first surface.

22. The shutter glasses of claim 15, wherein:
the shutter has opposite first and second ends and a middle portion therebetween, and
when the shutter is closed, the first and second ends are generally coplanar with the middle portion, and when the shutter is opened, the first and second ends are each deformed toward the middle portion and away from the substrate, so as to form a generally arcuate shape.

23. The shutter glasses of claim 15, wherein:
the shutter has opposite first and second ends and a middle portion therebetween, and
when the shutter is closed, the first and second ends are generally coplanar with the middle portion, and when the shutter is opened, the first and second ends are each deformed toward the middle portion and away from the substrate, so as to form a generally curled shape.

24. The shutter glasses of claim 15, wherein:
an end of the shutter is slidably coupled to the control electrode, the shutter sliding between an opened position and a closed position according to a voltage applied to the control electrode.

25. The shutter glasses of claim 15, wherein:
an end of the shutter is pivotably attached to at least one of the control electrode and the substrate, the shutter pivoting between an opened position and a closed position according to a voltage applied to the control electrode.

26. A method of manufacturing shutter glasses including a left eye shutter and a right eye shutter for a 3D image display, the method comprising:
fabricating a MEMS element within at least one of the left eye shutter and the right eye shutter the MEMS element configured to control an opening and a closing of the at least one of the left eye shutter and the right eye shutter.

27. A method of manufacturing a 3D image display system comprising:
preparing a display for alternately displaying left eye images and right eye images; and
preparing shutter glasses including a left eye shutter and a right eye shutter,
wherein at least one of the left eye shutter and the right eye shutter includes a MEMS element.

28. Shutter glasses for a 3D image display comprising:
MEMS elements controlling an opening and a closing of shutters of the shutter glasses.
